(19) United States
(12) Patent Application Publication
(10) Pub. No.: US 2019/0332721 A1
(43) Pub. Date: Oct. 31, 2019

(54) ELECTRONIC DEVICE AND METHOD FOR PROVIDING VIRTUAL ASSISTANCE (VA)-BASED CONTENT INTERACTION

(71) Applicant: Brillio LLC, Edison, NJ (US)

(72) Inventors: Sadeev Pathiyattuthody, Bangalore (IN); Pramod Nagaraj Bharadwaj, Bangalore (IN); Benjamin Rowland Antonio Laurenco, Bangalore (IN)

(21) Appl. No.: 16/123,159

(22) Filed: Sep. 6, 2018

(30) Foreign Application Priority Data
Apr. 26, 2018 (IN) 201841015848

(51) Int. Cl. G06F 17/30; G06F 15/18; G10L 15/16; G06F 3/0484

(52) U.S. Cl. CPC G06F 17/30867; G06F 3/0484; G10L 15/16; G06F 15/18

(57) ABSTRACT

Embodiments herein provide a method for VA based content interaction in electronic device. The method includes displaying a VA application in a first portion and a browsing application in a second portion of the screen of the electronic device. The method also includes receiving at least one user command at the VA application to view a specific content of the browsing application and providing at least one response to the at least one user command by the VA application while dynamically displaying the specific content of the browsing application based on the at least one user command. Further, the method includes automatically creating a milestone index based on the at least one user command, the at least one response by the VA application and a state of the browsing application and displaying the milestone index in a third portion of the screen of the electronic device.

### FIELD OF INVENTION

The embodiments herein generally relates to user interaction. More particularly related to an electronic device and method for providing a Virtual Assistance (VA)-based content interaction. The present application is based on, and claims priority from an Indian Application Number 201841015848 filed on 26 Apr. 2018, the disclosure of which is hereby incorporated by reference herein.

### BACKGROUND

In general, when a user accesses a browsing application the user has to perform a series of operations/steps in order to complete a task on the browsing application. The series of operations performed by the user indicates a journey of the user in the browsing application. Further, if the user wants to navigate back in the journey, then the user will have to repeat the series of operations which was already performed by the user. The repetition of the series of operations performed by the user can be time consuming and hamper user experience.

For example, consider the user wants to purchase footwear on an e-commerce site. After opening the e-commerce site, at first step the user selects a brand of the footwear, at second step the user selects a color of the footwear, at third step the user selects a material of the footwear and at fourth step the user selects a size of the footwear. Further, the user proceeds for payment. Before making the payment, if the user decides to buy the footwear from a different brand then the user will have to perform the back operation four times in order to re-select the brand. Further, the user will have to repeat the actions of selecting the other parameters like the color, the material, the size of the footwear, as the user selection will not be updated.

The above information is presented as background information only to help the reader to understand the present invention. Applicants have made no determination and make no assertion as to whether any of the above might be applicable as prior art with regard to the present application.

### SUMMARY

Accordingly the embodiments herein provide a method for VA based content interaction in an electronic device. The method includes displaying a VA application in a first portion of a screen of the electronic device and a browsing application in a second portion of the screen of the electronic device. The method also includes receiving at least one user command at the VA application in the first portion to view a specific content of the browsing application. Further, the method also includes providing at least one response to the at least one user command by the VA application in the first portion while performing a dynamic action to display the specific content of the browsing application in the second portion based on the at least one user command. Furthermore, the method also includes automatically creating a milestone index comprising a plurality of interconnected actionable checkpoints based on the at least one user command, the at least one response to the at least one user command by the VA application, and a state of the browsing application displaying the specific content based on the dynamic action. Finally, the method also includes displaying the milestone index in a third portion of the screen of the electronic device.

In an embodiment, each of the actionable checkpoints indicates the dynamic action, a filter component to perform the dynamic action, and the specific state of the browsing application displaying the specific content filtered based on the filter component.

In an embodiment, performing the dynamic action to display the specific content of the browsing application in the second portion based on the at least one user command includes extracting a filter component from at least one of the at least one user command and the at least one response from the VA application. Further, the method includes performing the dynamic action by determining the specific content by filtering content of the browsing application based on the filter component and displaying the specific content of the browsing application in the second portion of the screen.

In an embodiment, the method further includes detecting an actionable check point selected from the plurality of interconnected actionable checkpoints displayed in the third portion of the screen and determining a dynamic action, a filter component to perform the dynamic action, and a specific state of the browsing application corresponding to the selected actionable check point. Further, the method also includes automatically traversing to the specific state of the browsing application displaying the specific content filtered based on the filter component in the second portion of the screen.

In an embodiment, the method further includes detecting that the actionable check point from the plurality of interconnected actionable checkpoints modified by a user and automatically updating the milestone index by modifying at least one of a dynamic action, a filter component to perform the dynamic action, and a specific state of the browsing application corresponding to the selected actionable check point associated with remaining actionable checkpoints from the plurality of interconnected actionable checkpoints based on the modification actionable checkpoint.

In an embodiment, the method further includes detecting a modified actionable check point selected from the plurality of modified actionable checkpoints and determining a modified dynamic action, a modified filter component to perform the modified dynamic action, and a modified specific state of the browsing application corresponding to the modified actionable check point. Further, the method also includes automatically traversing to the modified state of the browsing application displaying the modified specific content filtered based on the modified filter component.

In an embodiment, the method further includes sharing the milestone index with other users to dynamically traverse across the specific content of the browsing application.

In an embodiment, the milestone index simulates a browsing journey of a user in the browsing application in the form of actionable checkpoints to allow the user to seamlessly traverse across the specific content of the browsing application.

In an embodiment, the third portion is embedded in or overlaid at the first portion or the second portion of the screen.

Accordingly the embodiments herein provide a method for VA based content interaction in an electronic device. The method includes receiving by a first user a milestone index comprising a plurality of interconnected actionable checkpoints indicating a browsing journey of a browsing application of a second user and simulating the milestone index of the browsing application of the second user at a first portion of the screen of the electronic device of the first user. Further, the method also includes detecting an actionable checkpoint selected from the plurality of actionable checkpoints by the first user and determining a dynamic action to be performed and a filter component used to perform the dynamic action corresponding to the selected actionable check point. Furthermore, the method also includes performing the dynamic action by filtering content of the browsing application based on the filter component automatically traversing the first user to a specific state of the browsing application displaying the filtered content in a second portion of the screen.

In an embodiment, each of the actionable checkpoints indicates the dynamic action, a filter component to perform the dynamic action, and the specific state of the browsing application displaying the specific content filtered based on the filter component.

In an embodiment, the milestone index is dynamically created by monitoring at least user command of the second user at the VA application to view a specific content of the browsing application, at least one response to the at least one user command by the VA application, and at least one specific state of the browsing application displaying a specific content from the browsing application. Further, the method also includes automatically creating the milestone index comprises the plurality of interconnected actionable checkpoints based on the at least user command, the at least one response to the at least one user command by the VA application, and the at least one state of the browsing application displaying the specific content.

In an embodiment, the method further includes detecting that actionable check point from the plurality of interconnected actionable checkpoints modified by a user. Further, the method also includes automatically updating the milestone index by modifying at least one of a dynamic action, a filter component to perform the dynamic action, and a specific state of the browsing application corresponding to the selected actionable check point associated with remaining actionable checkpoints from the plurality of interconnected actionable checkpoints based on the modification actionable checkpoint.

In an embodiment, the method further includes detecting a modified actionable check point selected from the plurality of modified actionable checkpoints. The method also includes determining a modified dynamic action, a modified filter component to perform the modified dynamic action, and a modified specific state of the browsing application corresponding to the modified actionable check point. Further, the method also includes automatically traversing to the modified state of the browsing application displaying the modified specific content filtered based on the modified filter component.

In an embodiment, the method further includes sharing the milestone index with other users to dynamically traverse across the specific content of the browsing application.

Accordingly the embodiments herein provide a method for VA based content interaction in an electronic device. The method includes simulating milestone index comprising a plurality of interconnected actionable checkpoints indicating a browsing journey of a user in a browsing application at a first portion of the screen of the electronic device. The method includes detecting that at least one of a dynamic action and a filter component associated with a first actionable checkpoint from the plurality of interconnected actionable checkpoints are modified by a user. Further, the method includes automatically updating the milestone index by modifying at least one of a dynamic action, a filter component used to perform the dynamic action, and a specific state of the browsing application associated with remaining actionable checkpoints from the plurality of interconnected actionable checkpoints based on the modified dynamic action and the modified filter component of the first actionable checkpoint.

In an embodiment, the method further includes detecting a modified actionable check point selected from the plurality of modified actionable checkpoints. The method also includes determining a modified dynamic action, a modified filter component to perform the modified dynamic action, and a modified specific state of the browsing application corresponding to the modified actionable check point. Further, the method also includes automatically traversing to the modified state of the browsing application displaying the modified specific content filtered based on the modified filter component.

In an embodiment, the method further includes sharing the updated milestone index with other users to dynamically traverse across the specific content of the browsing application.

In an embodiment, each of the actionable checkpoints indicates the dynamic action, a filter component to perform the dynamic action, and the specific state of the browsing application displaying the specific content filtered based on the filter component.

Accordingly the embodiments herein provide an electronic device for providing a virtual assistance (VA)-based content interaction. The electronic device includes a memory, a processor, a virtual assistant engine and a milestone index engine. The virtual assistant engine is configured to display a VA application in a first portion of a screen of the electronic device, and a browsing application in a second portion of the screen of the electronic device. Further, the virtual assistant engine is also configured to receive at least one user command at the VA application in the first portion to view a specific content of the browsing application. Furthermore, the virtual assistant engine is also configured to provide at least one response to the at least one user command by the VA application in the first portion while performing a dynamic action to display the specific content of the browsing application in the second portion based on the at least one user command. The milestone index engine is configured to automatically create a milestone index comprising a plurality of interconnected actionable checkpoints based on the at least one user command, the at least one response to the at least one user command by the VA application, and a state of the browsing application displaying the specific content based on the dynamic action. Further, the milestone index engine is also configured to display the milestone index in a third portion of the screen of the electronic device.

Accordingly the embodiments herein provide an electronic device for providing a virtual assistance (VA)-based content interaction. The electronic device includes a memory, a processor and a milestone index engine. The milestone index engine is configured to receive by a first user a milestone index comprising a plurality of interconnected actionable checkpoints indicating a browsing journey of a browsing application of a second user and simulate the milestone index of the browsing application of the second user at a first portion of the screen of the electronic device. Further, the milestone index engine is also configured to detect an actionable checkpoint selected from the plurality of actionable checkpoints by the first user and determine a dynamic action to be performed and a filter component used to perform the dynamic action corresponding to the selected actionable check point. Furthermore, the milestone index engine is also configured to perform the dynamic action by filtering content of the browsing application based on the filter component and automatically traverse the first user to a specific state of the browsing application displaying the filtered content in a second portion of the screen.

Accordingly the embodiments herein provide an electronic device for providing a virtual assistance (VA)-based content interaction. The electronic device includes a memory, a processor and a milestone index engine. The milestone index engine is configured to simulate milestone index comprising a plurality of interconnected actionable checkpoints indicating a browsing journey of a user in a browsing application at a first portion of the screen of the electronic device and detect that at least one of a dynamic action and a filter component associated with a first actionable checkpoint from the plurality of interconnected actionable checkpoints are modified by a user. Further, the milestone index engine is also configured to automatically update the milestone index by modifying at least one of a dynamic action, a filter component used to perform the dynamic action, and a specific state of the browsing application associated with remaining actionable checkpoints from the plurality of interconnected actionable checkpoints based on the modified dynamic action and the modified filter component of the first actionable checkpoint.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications can be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1A is a block diagram of an electronic device for providing a virtual assistance (VA)-based content interaction, according to an embodiment as disclosed herein;

FIG. 1B is a block diagram of a virtual assistant engine of the electronic device, according to an embodiment as disclosed herein;

FIG. 1C is a block diagram of a milestone index engine of the electronic device, according to an embodiment as disclosed herein;

FIG. 2 illustrates a system architecture of the electronic device for providing the VA-based content interaction, according to an embodiment as disclosed herein;

FIG. 3 is a flow chart illustrating a method for providing VA-based content interaction in the electronic device, according to an embodiment as disclosed herein;

FIGS. 4A-4C illustrates various positions of displaying a milestone index on a screen of the electronic device, according to an embodiment as disclosed herein;

FIG. 5 is a sequence diagram illustrating a method for automatically creating the milestone index, according to an embodiment as disclosed herein;

FIG. 6 is an example illustrating various actionable checkpoints in the milestone index, according to an embodiment as disclosed herein;

FIGS. 7A-7L illustrates an example scenario of automatically creating the milestone index based on user command, response to the user command by a VA application and a state of browsing application, according to an embodiment as disclosed herein;

FIGS. 8A-8C illustrates an example scenario of automatically traversing to a specific state of a browsing application using the milestone index, according to an embodiment as disclosed herein;

FIGS. 9A-9C illustrates an example scenario of modification of the milestone index and automatically updating the milestone index based on the modification, according to an embodiment as disclosed herein;

FIGS. 10A-10B illustrates an example scenario of determining changes in user journey and automatically updating the milestone index based on the changes in the user journey, according to an embodiment as disclosed herein; and

FIGS. 11A-11B illustrates an example scenario of a first user sharing the milestone index with a second user, according to an embodiment as disclosed herein.

### DETAILED DESCRIPTION OF INVENTION

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments can be described and illustrated in terms of blocks which carry out a described function or functions. These blocks, which can be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and can optionally be driven by firmware and software. The circuits can, for example, be embodied in one or more semiconductor chips, or on substrate supports such as printed circuit boards and the like. The circuits constituting a block can be implemented by dedicated hardware, or by a processor (e.g., one or more programmed microprocessors and associated circuitry), or by a combination of dedicated hardware to perform some functions of the block and a processor to perform other functions of the block. Each block of the embodiments can be physically separated into two or more interacting and discrete blocks without departing from the scope of the disclosure. Likewise, the blocks of the embodiments can be physically combined into more complex blocks without departing from the scope of the disclosure.

Accordingly the embodiments herein provide a method for VA based content interaction in electronic device. The method includes displaying a VA application in a first portion of a screen of the electronic device and a browsing application in a second portion of the screen of the electronic device. The method also includes receiving at least one user command at the VA application in the first portion to view a specific content of the browsing application. Further, the method also includes providing at least one response to the at least one user command by the VA application in the first portion while performing a dynamic action to display the specific content of the browsing application in the second portion based on the at least one user command. Furthermore, the method also includes automatically creating a milestone index comprising a plurality of interconnected actionable checkpoints based on the at least one user command, the at least one response to the at least one user command by the VA application, and a state of the browsing application displaying the specific content based on the dynamic action. Finally, the method also includes displaying the milestone index in a third portion of the screen of the electronic device.

In the conventional methods and systems, in a conversation between the user and the virtual assistant application, at least one conversation item is tagged to a timeline which indicates a location of the tagged conversation item. Further, when the user selects one of the tagged conversation items, the electronic device navigates the user to the location of the tagged conversation item. Unlike conventional systems and methods, the proposed method includes determining actionable checkpoints based on the user command, the response to the user command by the VA application and the state of the browsing application. Further, when the user selects the actionable checkpoint from the milestone index, the user is navigated to the state of the browsing application and not the location of the actionable checkpoints (keyword) in the conversation.

Unlike conventional methods and systems, the proposed method allows the user to modify a specific actionable checkpoint in the milestone index and automatically update the other actionable checkpoints in the milestone index based on the modifications. Therefore, automatically updating of all the actionable checkpoints in the milestone index reduces the number of user interactions to be performed to manually re-select the filter components associated with the actionable checkpoint when one of the filter components is modified.

In the conventional methods and systems, a browsing history of the user is represented in the form of a tree structure with multiple branches and nodes. The user can select a specific branch or node to navigate to the specific state of the browsing application. Unlike to the conventional methods and systems, the proposed method is not a mere browsing history tracker. The proposed method includes three different applications such as the VA application, the browsing application and the milestone index. The actionable checkpoints in the milestone index are determined based on user commands provided to the VA application, the response of the VA application to the user commands and the specific state of the browsing application.

Unlike to the conventional methods and systems, the milestone index synchronizes the actions performed or to be performed on the browsing application with the user interactions on the VA application. Thus, the content in the browsing application changes in coordination with the user command in the VA application, with key activities/keywords extracted as actionable checkpoints and recorded in the milestone index.

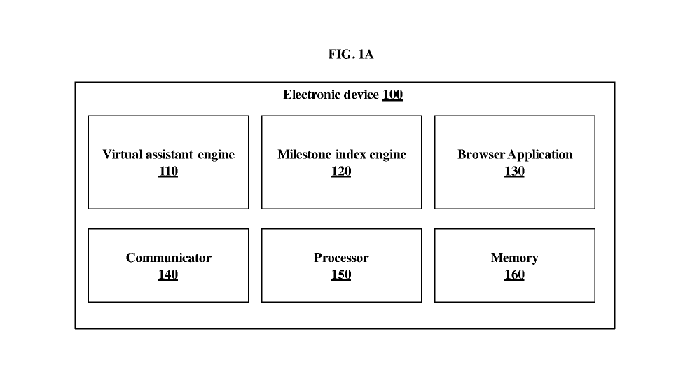

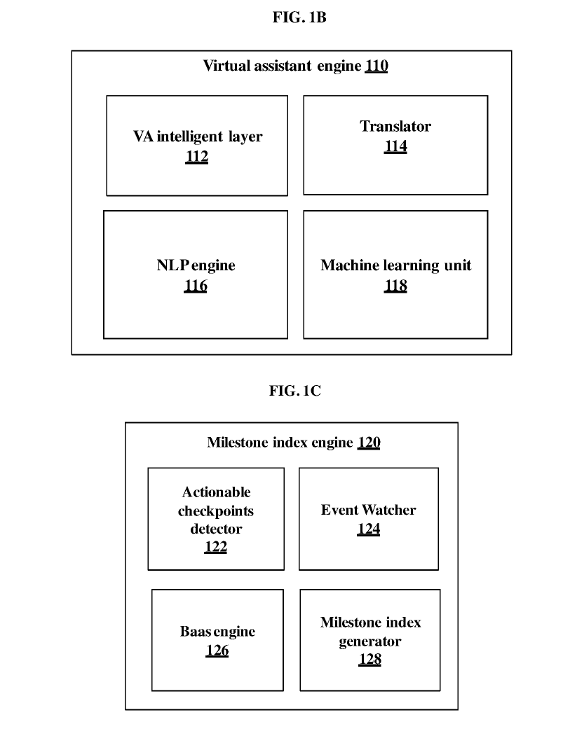

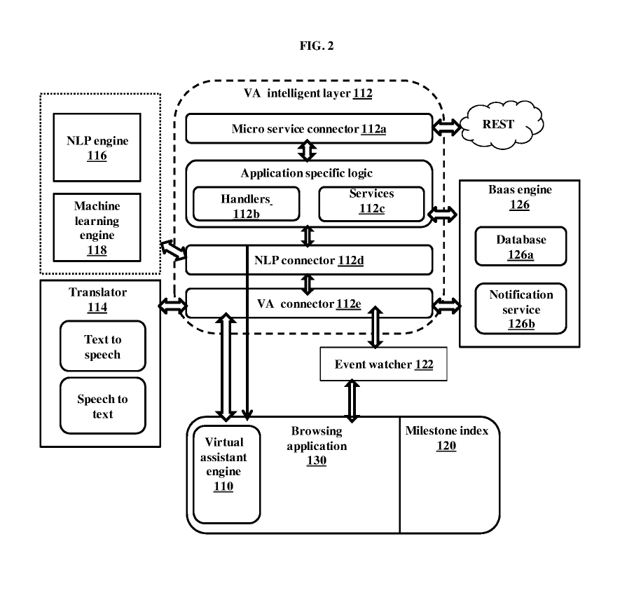

Referring now to the drawings, and more particularly to FIGS. 1 through 10B, where similar reference characters denote corresponding features consistently throughout the figures, there are shown preferred embodiments.

FIG. 1A is a block diagram of an electronic device 100 for providing the VA-based content interaction, according to an embodiment as disclosed herein.

Referring to the FIG. 1A, the electronic device 100 can be, for example, a laptop, a Personal Computer, a mobile phone, a smart phone, Personal Digital Assistant (PDA), a tablet, a wearable device, or the like. In an embodiment, the electronic device 100 includes a virtual assistant engine 110, a milestone index engine 120, a browser application 130, a communicator 140, a processor 150 and a memory 160.

In an embodiment, the virtual assistant engine 110 is configured to display a VA application in a first portion of the screen of the electronic device 100 and the browsing application in a second portion of the screen of the electronic device 100. Further, the virtual assistant engine 110 is also configured to receive an at least one user command at the VA application in the first portion to view the specific content of the browsing application. The at least one user command can be in the form of text, speech etc. Further, the virtual assistant engine 110 is also configured to provide the at least one response to the at least one user command by the VA application in the first portion while performing a dynamic action to display the specific content of the browsing application in the second portion based on the at least one user command. The at least one response by the VA application is provided in the form of text in the first portion of the screen of the electronic device 100. The at least one response may include options provided by the VA application for the user to select. In an example, the user requests for flight information from a destination X to a destination Y. The VA application may provide options for the user to select such as date, timing details, etc. The at least one user command and the at least one response by the VA application creates a conversation between the user and the VA application.

Further, the virtual assistant engine 110 is also configured to extract the filter component from the at least one of the at least one user command and the at least one response from the VA application. For example, if the user command is ‘I want to buy a red dress having full sleeves’, then the filter components extracted by the virtual assistant engine 110 includes ‘red dress’ and ‘full sleeves’. In response to the user command, the VA engine 110 responds by providing option to select based on brands, price, size etc. The user then selects the ‘brand’ option. Then, the other filter component determined is ‘brand’ based on the response of the VA to the user command. The virtual assistant engine 110 is also configured to invoke the actions performed on the milestone index. For example, the user can provide commands such as “I want to repeat my previous journey with black dots on cream shirt instead of a white shirt”.

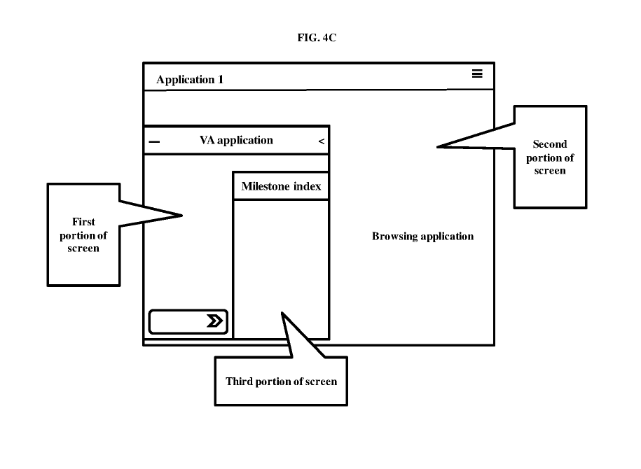

In an embodiment, the milestone index engine 120 is configured to automatically create a milestone index based on the at least one of the user command, the at least one response to the at least one user command by the VA application, and the state of the browsing application displaying the specific content based on the dynamic action. The dynamic action may be for example performing an action on the browsing application to determine the specific content (e.g., accessing a browsing application, navigating to a specific location within the browsing application, performing a searching operation on the browsing application, filtering the content on the browsing application based on the filter component, purchasing a product etc). The milestone index is a container which is automatically generated based on the at least one of the user command, the at least one response to the at least one user command by the VA application and the state of the browsing application displaying the specific content based on the dynamic action. The milestone index may be displayed in the third portion of the screen of the electronic device 100 (further explained in FIGS.4A-4C).

Further, the milestone index includes a plurality of interconnected actionable checkpoints which indicates the dynamic action, the filter component to perform the dynamic action, and the specific state of the browsing application displaying the specific content filtered based on the filter component. Further, the milestone index engine 120 is also configured to display the milestone index in the third portion of the screen of the electronic device 100. The actionable checkpoints are provided in the form of interactable labels, buttons and field values. Every actionable checkpoint is interconnected to the preceding and the succeeding actionable checkpoint in the milestone index forming a chain of interconnected actionable checkpoints.

Further, the milestone index engine 120 is also configured to maintain sessions of the user during the user journey. For example, consider that the user quits a current browsing session then the state of the milestone index is saved. Further, when the user starts a new browsing session, the milestone index engine 120 displays a prompt to the user to restore the previous state of the milestone index.

Furthermore, the milestone index engine 120 is also configured to create and provide two different milestone index indicating two different user journeys. For example, the user can provide commands such as “carry out two journeys with black shirt and cream shirt”, “repeat till mid of past user journey”, “carry out till address of the past journey” etc which will fetch two different milestone indices.

In an embodiment, the browser application 130 is the third portion of the screen of the electronic device 100 and is configured to display the specific content based on the filter components extracted from the at least one of the user commands, the response to the user commands by the VA application and the state of the browsing application. Further, the milestone index tracks the browsing journey of the user in the browsing application in the form of actionable checkpoints to allow the user to seamlessly traverse across the specific content of the browsing application.

In an embodiment, the communicator 140 is configured to communicate internally with the units and externally with networks. Further, the communicator is also configured to share the milestone index with other users to dynamically traverse across the specific content of the browsing application 130.

In an embodiment, the processor 150 is configured to interact with the units in the electronic device 100 to perform the functionalities of the corresponding units.

The memory unit 160 can include one or more computer-readable storage media. The memory unit 160 can include non-volatile storage elements. Examples of such non-volatile storage elements can include magnetic hard discs, optical discs, floppy discs, flash memories, or forms of electrically programmable memories (EPROM) or electrically erasable and programmable (EEPROM) memories. In addition, the memory unit 160 can, in some examples, be considered a non-transitory storage medium. The term “non-transitory” can indicate that the storage medium is not embodied in a carrier wave or a propagated signal. However, the term “non-transitory” should not be interpreted that the memory unit 160 is non-movable. In some examples, the memory unit 160 can be configured to store larger amounts of information than the memory. In certain examples, a non-transitory storage medium can store data that can, over time, change (e.g., in Random Access Memory (RAM) or cache.

The FIG. 1A shows exemplary system but it is to be understood that other embodiments are not limited thereon. In other embodiments, the system can include less or more number of units in the electronic device 100. Further, the labels or names of the units in the electronic device 100 are used only for illustrative purpose and does not limit the scope of the invention. One or more units can be combined together to perform same or substantially similar function in the system.

FIG. 1B is a block diagram of the virtual assistant engine 110 of the electronic device 100, according to an embodiment as disclosed herein.

In an embodiment, the virtual assistant engine 110 includes a VA intelligent layer 112, a translator 114, a natural language processing (NLP) engine 116 and a machine learning engine 118.

In an embodiment, the VA intelligent layer 112 is configured to receive the user commands in the form of text, speech, etc. Further, the VA intelligent layer 112 is also configured to determine various parameters associated with the user command such as content of the user command, a type of the user command, channel type, channel ID, user ID, etc. The user ID is unique to every user and is used to identify the user who is providing the user command. Further, the various parameters associated with the user command are also used to determine user statistics which is stored in the memory 160. The VA intelligent layer 112 is also configured to share the various parameters associated with the user command with the Backend as a Service (BaaS) engine 126. Further, the VA intelligent layer 112 ensures that the form in which the virtual assistant engine 110 responds to the user command is in accordance with the form of the user command i.e., speech response for user command provided in the form of speech and text response for user command provided in the form of text.

Furthermore, the VA intelligent layer 112 is also configured to process the user command before transmitting the user command to the NLP engine 116. Further, the response received from the NLP engine 116 is reformatted, processed and sent out to the user, by the VA intelligent layer 112.

In an embodiment, the translator 114 is configured to perform speech to text and text to speech conversions on the user command received by the VA intelligent layer 112. The translator 114 performs the speech to text conversion using neural networks. Further, the text to speech conversion is achieved by the translator 114 using text to speech (TTS) converters which produce speech by concatenating the pieces of prerecorded sounds stored in the electronic device 100.

In an embodiment, the natural language processing (NLP) engine 116 is configured to pre-process the user command, understand the various parameters of the user command and generate the response to the user command.

In an embodiment, the machine learning unit 118 is pre-trained with sample user utterances as a training input. The sample user utterances are known as intents. In the user commands, important key words are highlighted and are called entities. The entities enable the machine learning unit 118 to pattern matching and trigger the right intent. Every intent is associated with the response and the dynamic action.

The machine learning unit 118 is configured to allow the VA engine 110 to learn from the user commands and language models developed by the NLP engine 116. The machine learning unit 118 works on a threshold score based user command matching. The training component helps in training the NLP engine 116 to match the inputs better by logging all the user commands and responses. The NLP engine 116 moves certain user commands to a training zone which supports manual training of the VA engine 110.

The FIG. 1B shows exemplary system but it is to be understood that other embodiments are not limited thereon. In other embodiments, the system can include less or more number of units in the electronic device 100. Further, the labels or names of the units in the electronic device 100 are used only for illustrative purpose and does not limit the scope of the invention. One or more units can be combined together to perform same or substantially similar function in the system.

FIG. 1C is a block diagram of the milestone index engine 120 of the electronic device 100, according to an embodiment as disclosed herein.

In an embodiment, the milestone index engine 120 includes an actionable checkpoint detector 122, an event watcher 124, a BaaS engine 126 and a milestone index generator 128.

In an embodiment, the actionable checkpoint detector 122 is configured to receive the inputs from the NLP engine 116 and transform the user command into actionable checkpoints. The actionable checkpoint detector 122 maps the user commands with pre-stored patterns, followed by analysis based on the inputs received from the machine learning unit 118 of the NLP engine 116. Further, the actionable checkpoint detector 122 in conjunction with the event watcher 122 detects the actionable checkpoint based on the at least one user command, the at least one response to the at least one user command by the VA engine 110 and state of the browsing application. Therefore, the actionable checkpoint detector 122 detects actionable checkpoints based on user interactions on the first portion and the second portion of the screen of the electronic device 100.

Further, the actionable checkpoint detector 122 is also configured to determine the modifications made by the user to the at least one actionable checkpoint and update the modifications in all the following actionable checkpoints in the milestone index.

In an embodiment, the event watcher 124 is configured to monitor the interactions of the user in the second portion of the screen of the electronic device 100 i.e., on the browsing application. Further, the event watcher 124 shares the information related to the interactions of the user on the browsing application with the actionable checkpoint detector 122, which also detects actionable checkpoints based on the shared the information. Further, the event watcher 124 is configured to determine the actionable checkpoint selected by the user from the milestone index and navigate the user to the specific state of the browsing application associated with the actionable checkpoint selected by the user.

Unlike the conventional methods and systems, which track user interactions only in one portion of the screen of the electronic device 100 i.e., either the browsing application or the chat interface, the presence of the event watcher 124 enables the proposed method to track user interactions in any portion of the screen of the electronic device 100.

In an embodiment, the Backend as a Service (BaaS) engine 126 is configured to determine the contents to be provided on the browsing application 130 based on the filter components determined. The BaaS engine 126 includes a database 126a and a notification service 126b (as disclosed in FIG. 2) which provides notification service capabilities. The database 126a includes a generic database and a user-specific database. The generic database maintains a table containing the entries of the entities, actionable checkpoints corresponding to the entities, response to be updated on the VA application and pointers to the services to be called for loading up the content to be displayed on the browsing application 130. The user-specific database is responsible for storing all the user related data. The conversations are also stored for future analytics. Further, the stored conversations help in sending push notifications to the user by providing relevant user identification information to the notification service 126b.

In an embodiment, the milestone index generator 128 is configured to generate the milestone index based on the inputs from the actionable checkpoint detector 122. The milestone index includes the plurality of interconnected actionable checkpoints which indicate the journey of the user through the browsing application 130. Further, the milestone index is updated based on the changes made to the actionable checkpoints by the user.

The FIG. 1C shows exemplary system but it is to be understood that other embodiments are not limited thereon. In other embodiments, the system can include less or more number of units in the electronic device 100. Further, the labels or names of the units in the electronic device 100 are used only for illustrative purpose and does not limit the scope of the invention. One or more units can be combined together to perform same or substantially similar function in the system.

FIG. 2 illustrates system architecture of the electronic device 100 for providing the VA-based content interaction, according to an embodiment as disclosed herein.

Referring to the FIG. 2 in conjunction to FIGS. 1A-1C, the system architecture of the electronic device 100 for providing the VA-based content interaction is shown. The VA intelligent layer 112 receives the user command. A VA connector 112c which is part of the VA intelligent layer 112 acts as a gateway between the browsing application 130 and a NLP Connector 112d. On receiving the user command, the VA connector 112e determines the various parameters associated with the user command such as content of the user command, a type of the user command, channel type, channel ID, user ID, etc.

Further, the user command is routed to the translator 114 to perform speech to text conversion or text to speech conversion. Further, the converted response is returned to the VA connector 112e. Also, after generating a suitable response for the user command, the VA connector 112c re-routes the response to the translator 114. The translator 114 then replies back to the VA connector 112e with response in the same form as the user command which is sent to the user.

Further, the VA connector 112e interacts with the BaaS engine 126 and loads the user related data from the database 126a. The VA connector 112e attempts to match the user ID of the user command with the IDs fetched from the database 126a. If a match is found, all the user statistics of the user corresponding to the ID is loaded else the user statistics are registered with the database 126a keeping the ID as the reference. Further, in processing the user command the VA connector 112e formats the user command and sends the user command to the NLP Connector 112d. Further, the output of the NLP connector 112d is reformatted, processed and sent out to the user, by the VA connector 112e.

The NLP connector 112d acts as a gateway between the NLP engine 116 and the VA intelligent layer 112. The NLP engine 116 may be located in a cloud. The NLP connector 112d is configured to connect to the NLP engine 116 with appropriate parameters and receive the response from the NLP engine 116. In an example, JavaScript Object Notation (JSON) data may be received as response from the NLP engine 116 which is parsed to get the required content. The event watcher 122 monitors the user interactions on the browsing application 130 and based on the user navigation, suitable events are recorded actionable checkpoints after notifying the VA connector 112e.

In an embodiment, the application specific logic acts as a secondary line of intelligence. The application specific logic includes handlers 112b and services 112c. The handlers 112b can include chat handlers, web handlers and baas handlers. The chat handlers handle user commands from VA application, web handlers handle user interaction performed on the browsing application. The handlers 112b detect the actionable checkpoints to be updated on the milestone index depending on the understanding received from the NLP engine 116. The handlers 112b also decide the services 112c to be called in order to fetch data to be supplied in the browser application. After receiving appropriate information from the services layer 112c, the handlers 112b update the web interface with the information in a suitable way. The service 112c includes different functions to be called for getting the specific content to be displayed on the browsing application 130. The services 112c have a representational state transfer (REST) based architectures. Further, the services 112c makes use of micro service connector 112a to make the proper function calls and get the content.

In an embodiment, the micro service connector 112a is a service component which aids to connect the VA intelligent layer 112 with different micro services. This connector mainly supports REST based services i.e., to make REST API calls.

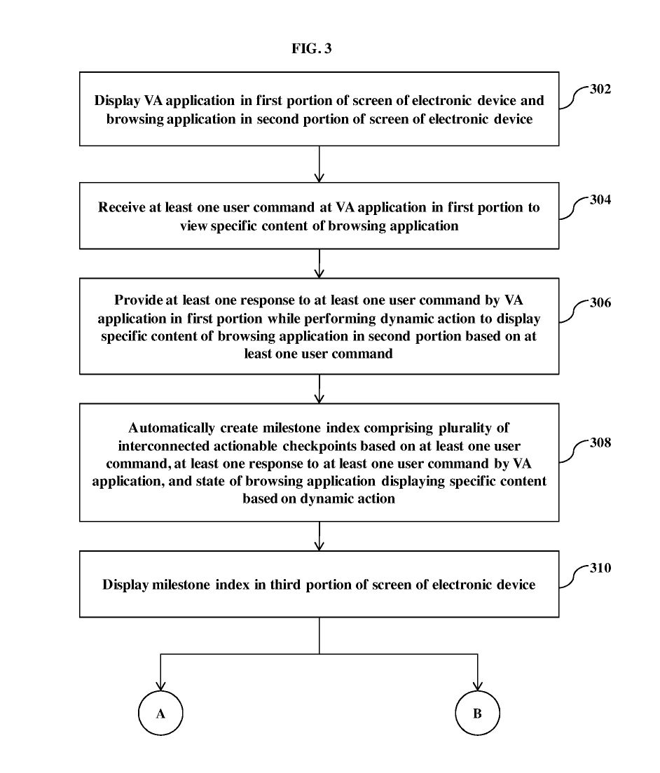

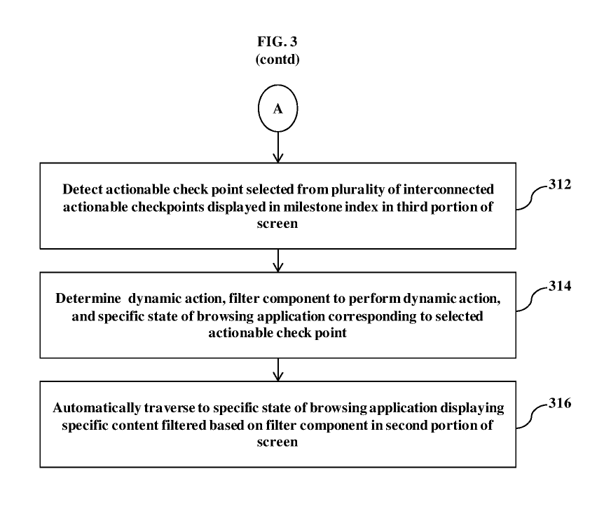

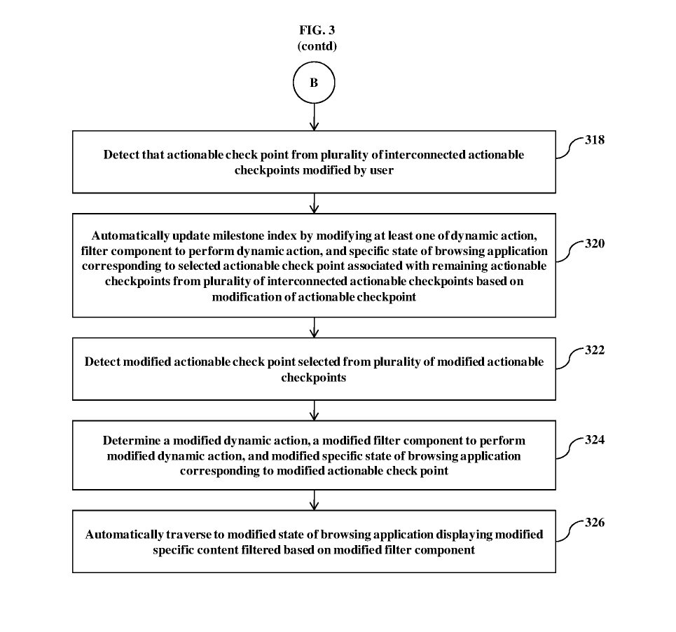

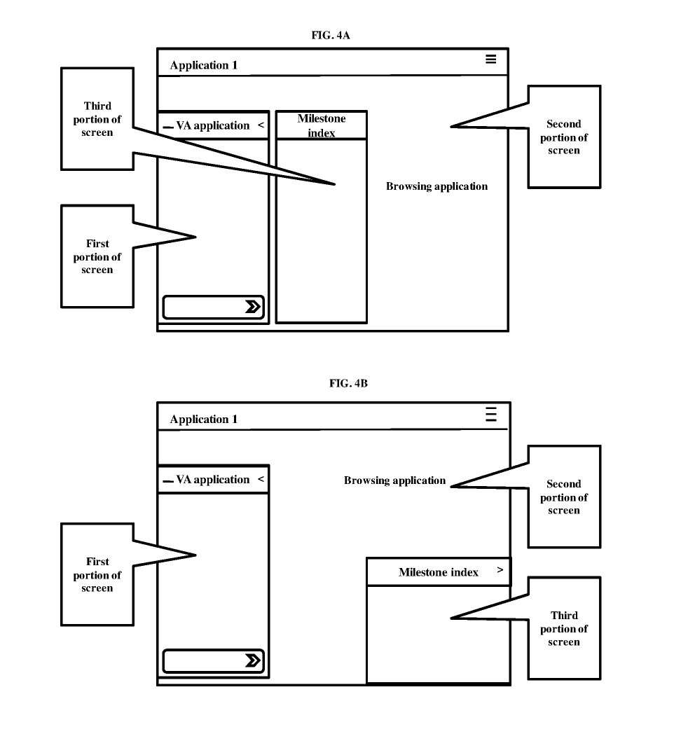

FIG. 3 is a flow chart 300 illustrating a method for providing VA-based content interaction in the electronic device 100, according to an embodiment as disclosed herein.

Referring to the FIG. 3, at step 302, the electronic device 100 displays the VA application in the first portion of the screen of the electronic device 100 and the browsing application in the second portion of the screen of the electronic device 100. For example, in the electronic device 100 as illustrated in the FIG. 1, the virtual assistant engine 110 can be configured to display the VA application in the first portion of the screen of the electronic device 100 and the browsing application in the second portion of the screen of the electronic device.

At step 304, the electronic device 100 receives the at least one user command at the VA application in the first portion to view the specific content of the browsing application. For example, in the electronic device 100 as illustrated in the FIG. 1, the virtual assistant engine 110 can be configured to receive the at least one user command at the VA application in the first portion to view the specific content of the browsing application.

At step 306, the electronic device 100 provides the at least one response to the at least one user command by the VA application in the first portion while performing the dynamic action to display the specific content of the browsing application in the second portion based on the at least one user command. For example, in the electronic device 100 as illustrated in the FIG. 1, the virtual assistant engine 110 can be configured to provide the at least one response to the at least one user command by the VA application in the first portion while performing the dynamic action to display the specific content of the browsing application in the second portion based on the at least one user command.

At step 308, the electronic device 100 automatically creates the milestone index comprising the plurality of interconnected actionable checkpoints based on the at least one user command, the at least one response to the at least one user command by the VA application, and the state of browsing application displaying the specific content based on the dynamic action. For example, in the electronic device 100 as illustrated in the FIG. 1, the milestone index engine 120 can be configured to automatically create the milestone index comprising the plurality of interconnected actionable checkpoints based on the at least one user command, the at least one response to the at least one user command by the VA application, and the state of browsing application displaying the specific content based on the dynamic action.

At step 310, the electronic device 100 displays the milestone index in the third portion of the screen. For example, in the electronic device 100 as illustrated in the FIG. 1, the milestone index engine 120 can be configured to display the milestone index in the third portion of the screen.

At step 312, the electronic device 100 detects the actionable check point selected from the plurality of interconnected actionable checkpoints displayed in the milestone index in the third portion of the screen. For example, in the electronic device 100 as illustrated in the FIG. 1, the milestone index engine 120 can be configured to detect the actionable check point selected from the plurality of interconnected actionable checkpoints displayed in the milestone index in the third portion of the screen.

At step 314, the electronic device 100 determines the dynamic action, the filter component to perform the dynamic action, and the specific state of the browsing application corresponding to the selected actionable check point. For example, in the electronic device 100 as illustrated in the FIG. 1, the milestone index engine 120 can be configured to determine the dynamic action, the filter component to perform the dynamic action, and the specific state of the browsing application corresponding to the selected actionable check point.

At step 316, the electronic device 100 automatically traverses to the specific state of the browsing application displaying the specific content filtered based on the filter component in the second portion of the screen. For example, in the electronic device 100 as illustrated in the FIG. 1, the milestone index engine 120 can be configured to automatically traverse to the specific state of the browsing application displaying the specific content filtered based on the filter component in the second portion of the screen.

At step 318, the electronic device 100 detects that the actionable check point from the plurality of the interconnected actionable checkpoints modified by the user. For example, in the electronic device 100 as illustrated in the FIG. 1, the milestone index engine 120 can be configured to detect that the actionable check point from the plurality of the interconnected actionable checkpoints modified by the user.

At step 320, the electronic device 100 automatically updates the milestone index by modifying the at least one of the dynamic action, the filter component to perform dynamic action, and the specific state of browsing application corresponding to the selected actionable check point associated with the remaining actionable checkpoints from the plurality of interconnected actionable checkpoints based on the modification of the actionable checkpoint. For example, in the electronic device 100 as illustrated in the FIG. 1, the milestone index engine 120 can be configured to automatically update the milestone index by modifying the at least one of the dynamic action, the filter component to perform dynamic action, and the specific state of browsing application corresponding to the selected actionable check point associated with the remaining actionable checkpoints from the plurality of interconnected actionable checkpoints based on the modification of the actionable checkpoint.

At step 322, the electronic device 100 detects the modified actionable check point selected from the plurality of modified actionable checkpoints. For example, in the electronic device 100 as illustrated in the FIG. 1, the milestone index engine 120 can be configured to detect the modified actionable check point selected from the plurality of modified actionable checkpoints.

At step 324, the electronic device 100 determines the modified dynamic action, the modified filter component to perform modified dynamic action, and modified specific state of the browsing application corresponding to the modified actionable check point. For example, in the electronic device 100 as illustrated in the FIG. 1, the milestone index engine 120 can be configured to determine the modified dynamic action, the modified filter component to perform modified dynamic action, and modified specific state of the browsing application corresponding to the modified actionable check point.

At step 326, the electronic device 100 automatically traverses to the modified state of the browsing application displaying modified specific content filtered based on the modified filter component. For example, in the electronic device 100 as illustrated in the FIG. 1, the milestone index engine 120 can be configured to automatically traverse to the modified state of the browsing application displaying modified specific content filtered based on the modified filter component.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

FIGS. 4A-4C illustrates various positions of displaying the milestone index on the screen of the electronic device 100, according to an embodiment as disclosed herein.

In the proposed method the VA application is displayed in the first portion of the screen of the electronic device 100 and the browsing application is displayed in the second portion of the screen of the electronic device 100. The VA application is the interactive section which receives the user commands. The browsing application portion displays the results based after filtering the content based on the user commands. The actionable checkpoints are recorded in the milestone index which is the third portion.

The milestone index can be provided in various ways. For example, the third portion can be overlaid on the second portion as shown in FIG. 4A. The third portion can be embedded in the second portion as shown in FIG. 4B. The third portion can also be embedded in the first portion as shown in FIG. 4C. The milestone index which is the third portion can be made collapsible on the first portion or the second portion of the screen of the electronic device 100.

Further, the milestone index can be separately stored in the electronic device 100 and shared with other users. Further, the milestone index is an active breadcrumb. Unlike the conventional UI components which are fixed, the structure of the milestone index varies with respect to the length of the user journey.

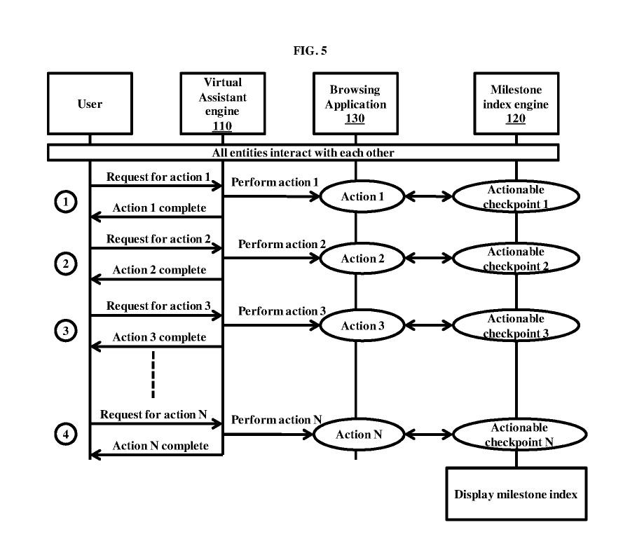

FIG. 5 is a sequence diagram illustrating a method for automatically creating the milestone index, according to an embodiment as disclosed herein.

Referring to the FIG. 5, at step 1, the user requests the virtual assistant engine 110 to perform an action 1 by providing commands such as for example look for book A, provide travel options to place X, etc. The user can provide the commands in the form of voice input, text input, etc. On receiving the command from the user, the virtual assistant engine 110 decodes the user command using the NLP engine 112 to determine the key words which can be used as the filter components. Further, the virtual assistant engine 110 instructs the browsing application 130 to perform the action 1. The browsing application 130 performs the action 1 based on the filter component determined by the VA engine 110. The milestone index engine 120 records the actionable checkpoint 1 based on the filter component determined by the VA engine 110 and also any action performed by the user directly on the browsing application 130. The actionable checkpoint 1 in the milestone index represents a specific state of the browsing application 130 which presents specific content based on the filter component. Further, the VA engine 110 sends an action 1 complete message to the user, indicating that the requested action 1 has been completed.

Similarly, at step 2, step 3, step 4 etc., the user can request for any number of actions to be performed by the VA engine 110, for example, action 2, action 3, action N, etc. For each action performed on the browsing application 130, the actionable checkpoints are recorded in the milestone index and displayed to the user in the third portion of the screen of the electronic device 100. The user can directly select the actionable checkpoint from the milestone index to navigate to the specific state of the browsing application 130.

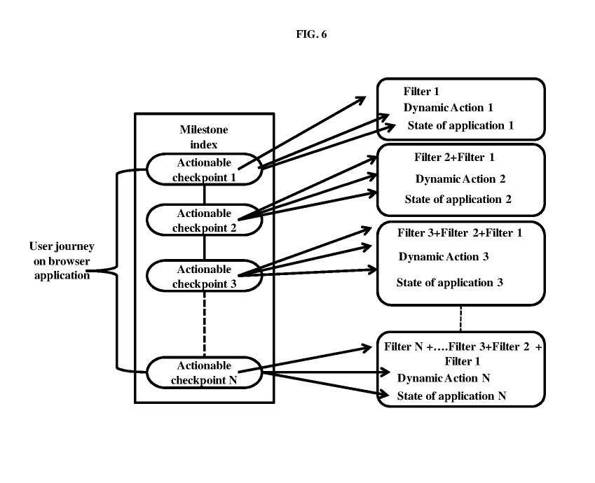

FIG. 6 is an example illustrating various actionable checkpoints in the milestone index, according to an embodiment as disclosed herein.

Referring to the FIG. 6, consider the milestone index containing N actionable checkpoints. Each of the N actionable checkpoints in the milestone index represents the dynamic action, the filter component to perform the dynamic action and the specific state of the browsing application 130 displaying the specific content filtered based on the filter component. Also for every actionable checkpoint, there is a defined set of responses which gets updated on the VA interface. For example, the user wants to buy a health insurance policy for a family of four. Then the user interacts with the VA application and provides command such as ‘I want to buy a health insurance policy’. The VA engine 110 decodes the command and determines ‘health insurance’ as actionable checkpoint 1. Further, the dynamic action associated with the actionable checkpoint 1 is ‘buy health insurance policy’, then the filter 1 associated with the actionable checkpoint 1 will be ‘health’. Further, the browsing application filters the results and displays only the health insurance policies on the screen of the electronic device 100. Therefore the state of the browsing application 130 displaying only the health insurance policies is also associated with the actionable checkpoint 1. Further, the user interacts with the VA application and provides inputs such as ‘sum to be insured’ which is recorded as actionable checkpoint 2. Therefore, the filter 2 will be the ‘X sum to be insured’ which is applied along with the filter 1. Further, the browsing application filters the results based on both the filter 1 and the filter 2 and provides the results on the screen of the electronic device 100.

Further, the milestone index includes the list of actionable checkpoints extracted and recorded during the course of the user interactions on the electronic device 100. Further, the actionable checkpoints are recorded for user interactions on the browsing application and the user interaction on the VA application. Further, the milestone container can have any number of actionable checkpoints based on the user interactions. The user interactions can be for example with a chat bot, on the webpage, a pop-up window, etc. The actionable checkpoints are interactable elements which can be selected by the user to navigate to the specific state of the browsing application 130.

For example, consider that the last actionable checkpoint recorded in the milestone index is associated with dynamic action 5. The user wants to navigate back to the state of the browsing application associated with a dynamic action 3. Then, the user selects the actionable checkpoint 3. As the user selects the actionable checkpoint 3, the milestone index directly traverses the user to the dynamic action 3 and displays the browsing application with the contents associated with the state of the browsing application 3 along with filter 3. Further, the in course of the journey of the user before arriving at the dynamic action 3 the journey includes the dynamic action 1 and the dynamic action 2. When the user navigates to actionable checkpoint 3, the states and filter associated with the dynamic action 1 and the dynamic action 2 are automatically applied. Hence, the user need not re-select the filters associated with the previous actions performed.

The milestone index allows the user to access the right information and also to navigate back and forth the user journey. Further, the milestone index helps the user to quickly change the decisions at a specific state with minimum number of interactions.

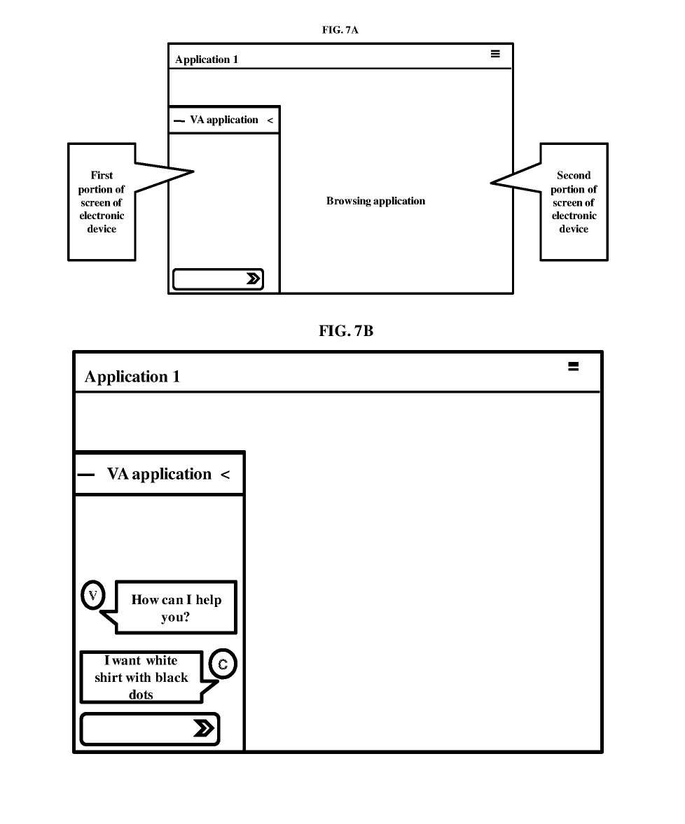

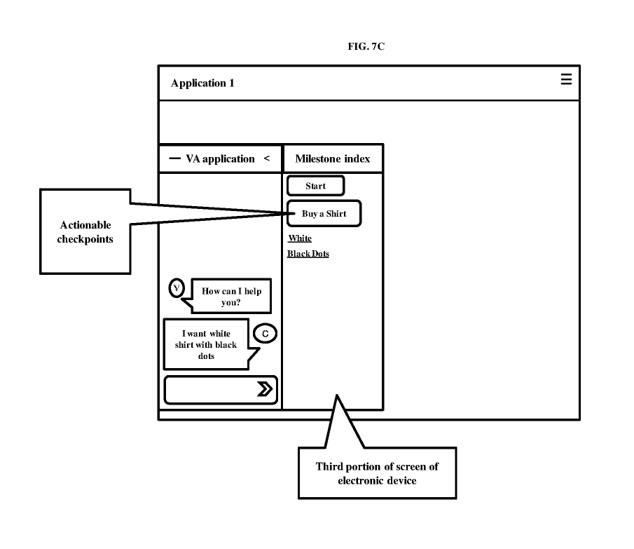

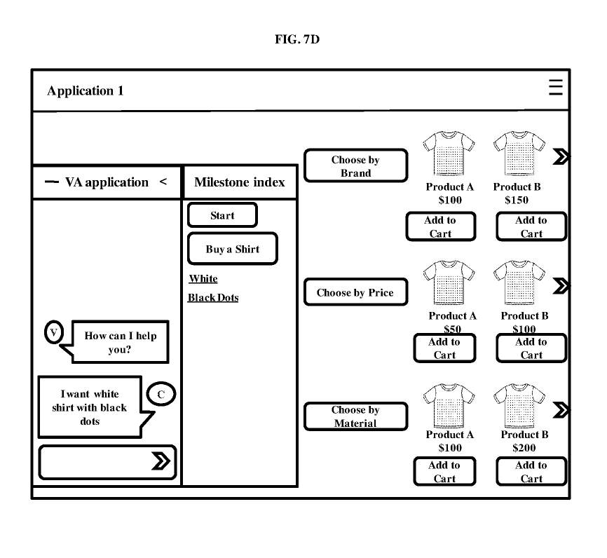

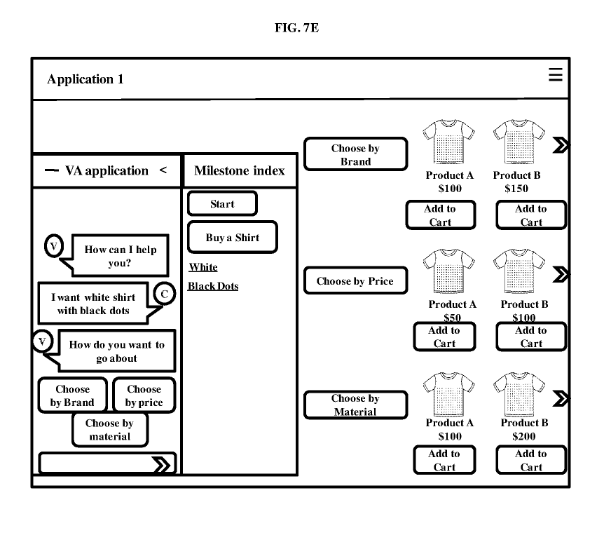

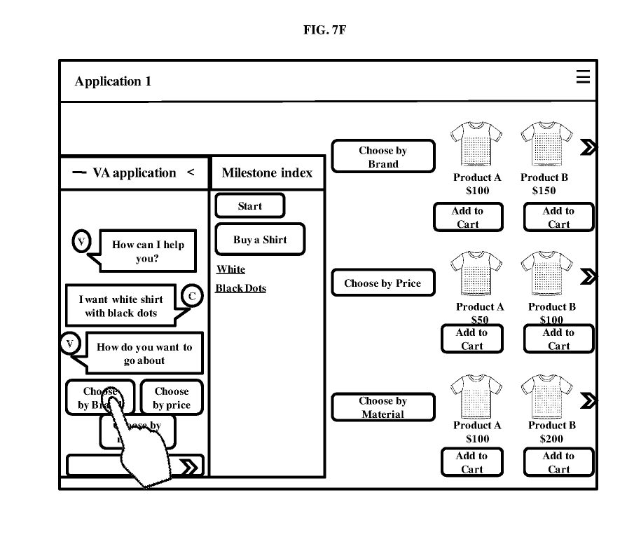

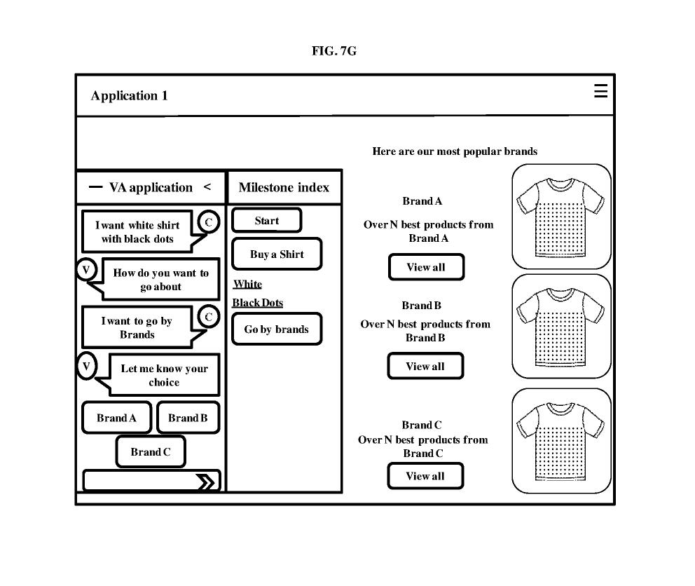

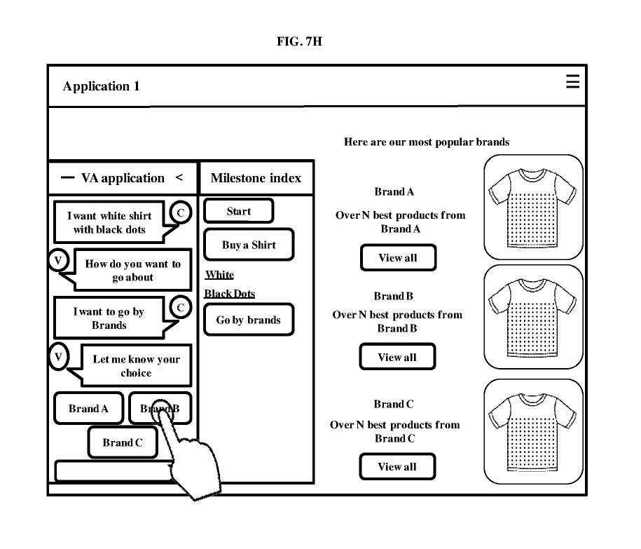

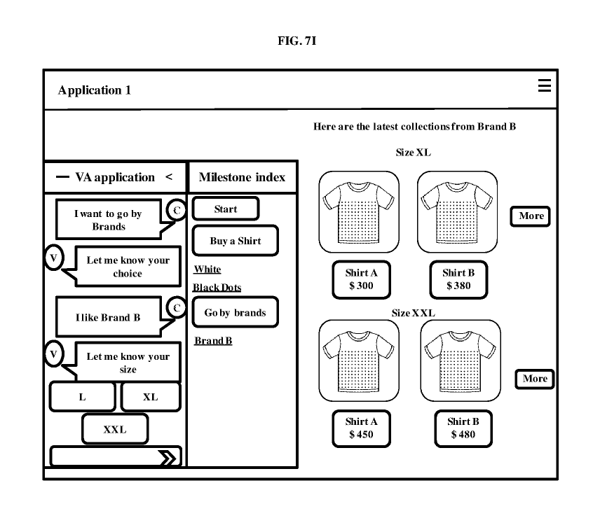

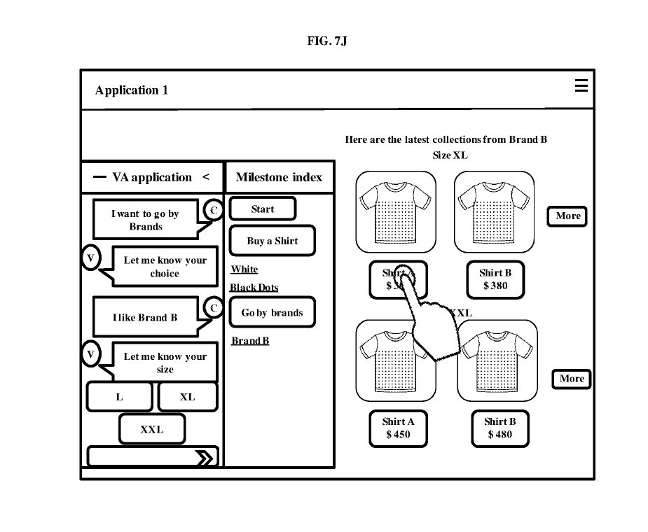

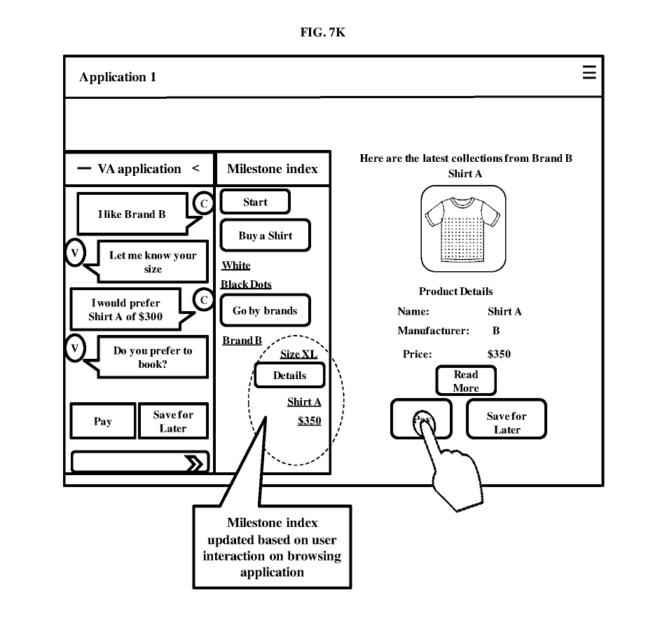

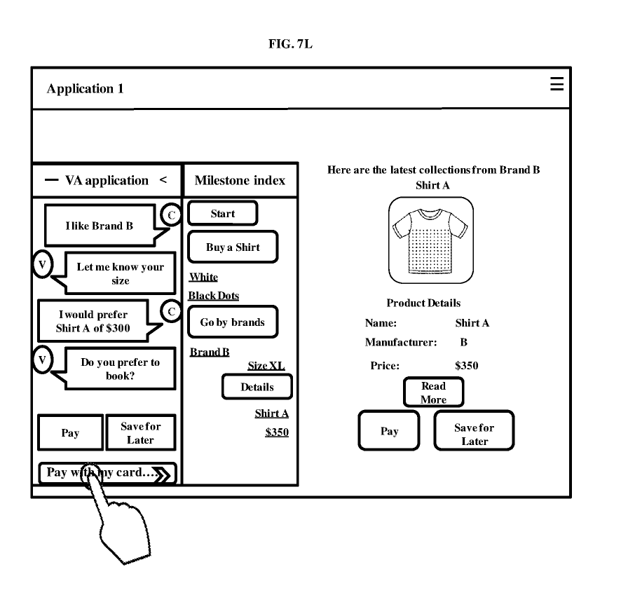

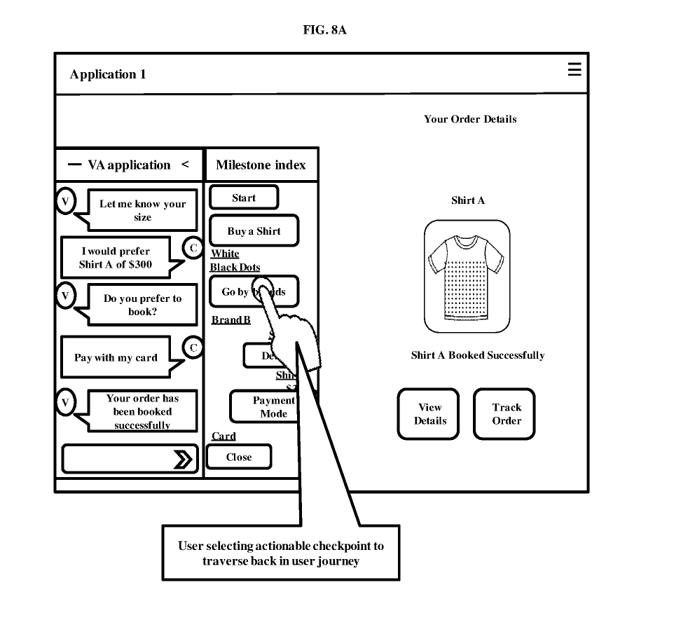

FIGS. 7A-7L illustrates an example scenario of automatically creating the milestone index based on the user command, the response to the user command by the VA application and the state of the browsing application 130, according to an embodiment as disclosed herein.

Consider a scenario that a user wishes to buy a shirt with specific design preferences. The user accesses an e-commerce application (i.e., the application 1) to search for the desired shirt. Referring to the FIG. 7A, virtual assistant (VA) application is provided in the first portion and the browsing application is provided in the second portion of the screen of the electronic device 100.

The electronic device 100 determines that the user has accessed the application 1 and the VA application initiates a conversation with the user by asking ‘How can I help you?’. Further, the user responds by providing the command to the VA application to display ‘white shirt with black dots’, as shown in FIG. 7B. The electronic device 100 identifies the milestones/key filter components provided by the user in the user commands. Further, the electronic device 100 automatically creates milestone index having plurality of interconnected actionable checkpoints based on the user commands, the response to the user command by the VA application and the state of the browsing application. The milestone index includes actionable checkpoints such as start, buy a shirt, white color, black dots, etc which are extracted from the user commands to the VA application. Further, the milestone index is provided on the third portion of the screen of the electronic device 100, as shown in FIG. 7C.

Referring to the FIG. 7D, the electronic device 100 filters the contents of the browsing application to determine the white shirts having black dots based on the filter component extracted from the user command. Further, the electronic device 100 displays only the white shirts having black dots in the browsing application.

Referring to the FIG. 7E, the VA application tries to refine the search process further by posing more questions to the user such as ‘How do you want to go about’ and provide options to the user to choose from like brand, price or material. The user selects the go by brand option (as shown in FIG. 7F). The electronic device 100 determines the ‘brand’ as the filter component and updates the milestone index by adding the actionable checkpoint for the ‘brand’ as shown in FIG. 7G. Further, the electronic device 100 filters all the white shirts having black dots based on the brands and displays in the browsing application, as shown in FIG. 7G.

Referring to the FIG. 7H, the user selects ‘brand B’ as the preferred brand to look for the white shirts having black dots. The user command to provide the white shirts having black dots belonging to ‘brand B’ is identified as the filter component and provided as the actionable checkpoint in the milestone index, as shown in FIG. 71. Further, the VA application also asks the user to provide the size preference among various sizes such as Large (L), extra large (XL), extra XL (XXL), etc.

Referring to the FIG. 7J, the user does not respond to the VA application, instead selects a specific shirt directly from the browsing application of the size XL and price $350. However, the user interactions on the browsing application are also observed and recorded by the electronic device 100 to determine the actionable checkpoints. Therefore, the milestone index is updated based on the user interaction on the browsing application, as shown in FIG. 7K. Also, the user interaction is also notes by the VA application as part of the conversation. Further, as the user selects the specific shirt, the browsing application provides other options to the user such as for payment, saving to cart, etc. The user selects the payment option on the browsing application, as shown in FIG. 7K. On determining that the user has chosen to make the payment, the VA application provides payment options to the user such as pay using card and the user selects the pay using the card option and places the order for the specific shirt, as shown in FIG. 7L. The VA application conveys the same in the form of conversation to the user.

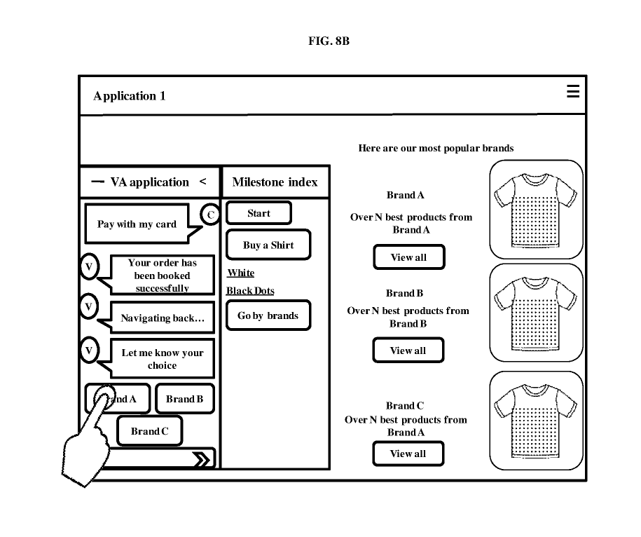

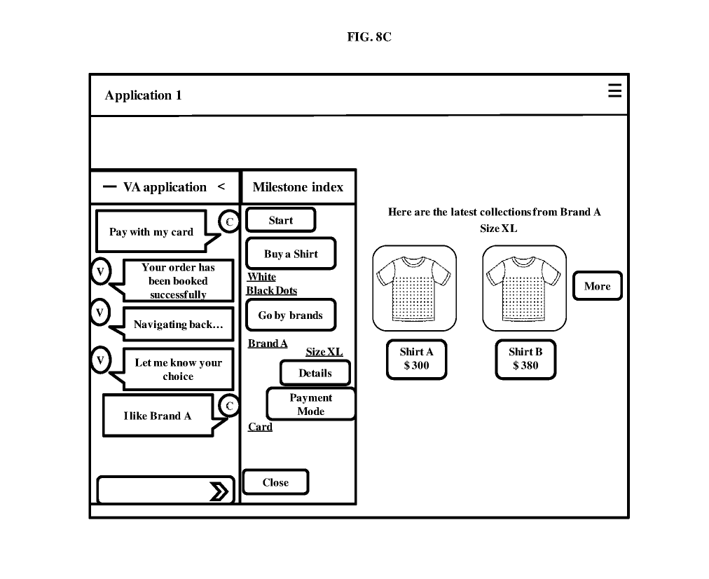

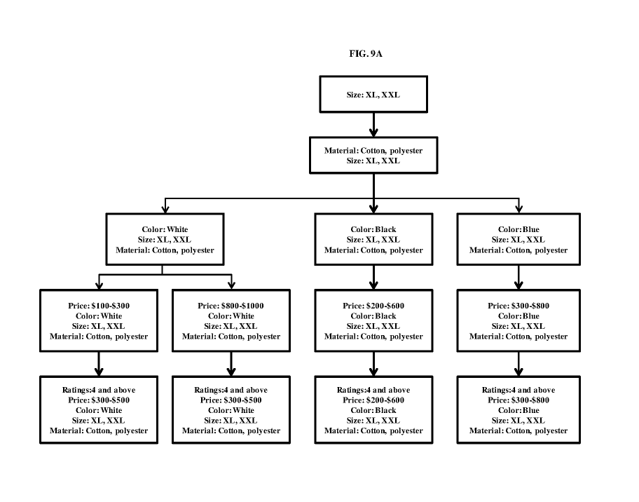

FIGS. 8A-8C illustrates an example scenario of automatically traversing to the specific state of the browsing application 130 using the milestone index, according to an embodiment as disclosed herein.

In conjunction with FIGS. 7A-7L, Consider the conditions as described with respect to FIG. 7L where the user has completed the payment and placed the order for the white shirt with black dots of brand B. At this point, the user wants to go back in user journey and have a look at the white shirts having black dots from other brands. Therefore, the user selects the ‘go by brand’ actionable checkpoint from the milestone index, as shown in FIG. 8A. The electronic device 100 determines the filter component and the specific state of the browsing application associated with the actionable checkpoint selected by the user. Further, the electronic device 100 automatically traverses to the specific state of the browsing application and displays the white shirts having black dots from all brands based on the brand filter component. Furthermore, the VA application asks the user to select the brand by providing a list of brands to the user, as shown in FIG. 8B. The user selects ‘brand A’ as the filter component to view the white shirts having black dots belonging to brand A. The electronic device 100 records the brand A as the actionable checkpoint and updates the milestone index accordingly, as shown in FIG. 8C. Therefore the user does not have re-enter the other choices such as preferred size, price range, payment mode etc, as the milestone index is automatically updated just with a change in brand while maintaining the other preferences of the user.

In the conventional methods and systems, the user has to manually re-enter the filter components once the user traverses back in the user journey. Unlike to the conventional methods and systems, the proposed method automatically updates the milestone index based on the modified user preference along with the other filter components which are not modified by the user. Therefore, the proposed method provides seamless traversing experience to the user.

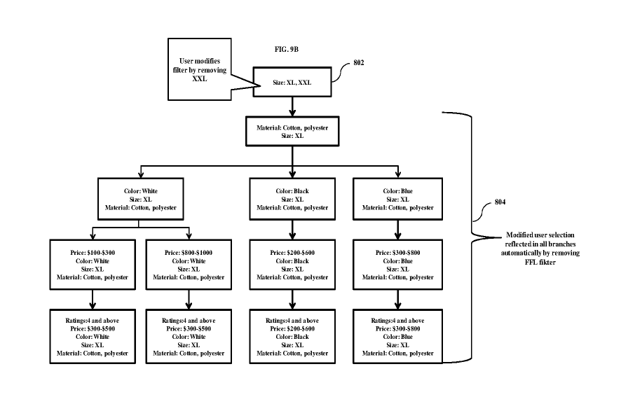

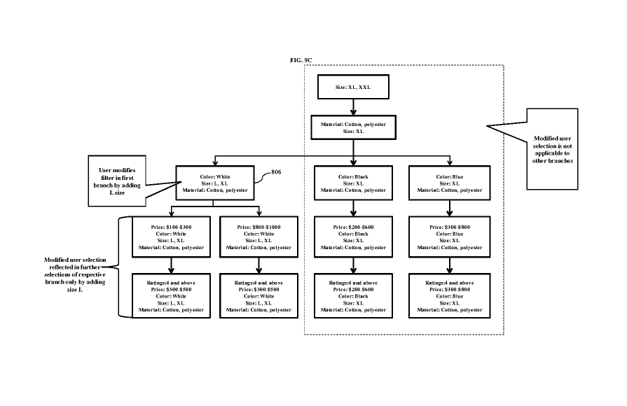

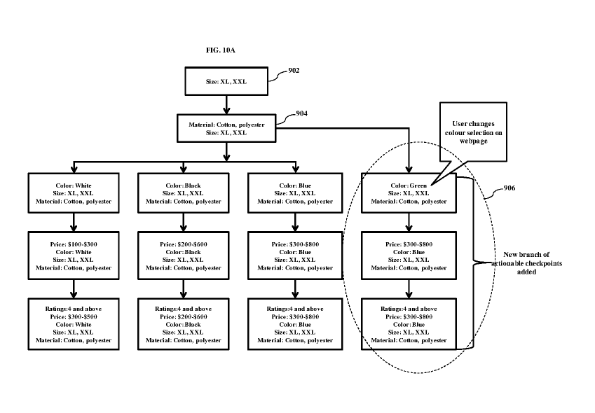

FIGS. 9A-9C illustrates an example scenario of modification of the milestone index and automatically updating the milestone index based on the modification, according to an embodiment as disclosed herein.

Consider an example scenario that the user wants to buy a dress on an e-commerce application (i.e., the browsing application). The user performs various interactions on the VA or/and the browsing application to search and select the required dress. The electronic device 100 determines the various interactions performed by the user on the VA or/and the browsing application and generates the milestone index with the actionable checkpoints as shown in FIG. 9A.

Referring to the FIG. 9B, at step 802, the user modifies the actionable checkpoint associated with the size filter component by removing XXL and retains only the size filter component XL. The electronic device 100 determines that the actionable checkpoint associated with the size filter component has been modified. Further, at step 804, the electronic device 100 automatically updates all the actionable checkpoints following the actionable checkpoint associated with the size filter component, to reflect the modification performed by the user. Therefore, the XXL size filter component is removed from all the actionable checkpoints based on the user modification, as shown in FIG. 9B.

In another embodiment, at step 806, the user modifies the size filter component of the actionable checkpoint which is associated with a specific branch of the milestone index i.e., the filter component searching for ‘white colour’ dresses, as shown in FIG. 9C. The electronic device 100 determines that the user has modified the actionable checkpoint to include the size filter component L along with the size filter component XL and automatically updates the milestone index. Therefore, the modified user selection is reflected in all the actionable checkpoints of the respective branch by adding the size filter component L, as shown in FIG. 9C. However, the modified user selection is not applicable to other branches of the milestone index.

In the conventional methods and systems, when the user wishes to modify the selection by changing the filter component at a specific point, the user will have to manually re-enter all the filters that follow the modified filter component again. Unlike, to the conventional methods and systems, the proposed method allows the user to modify the individual actionable checkpoints in the milestone index. Further, the electronic device 100 automatically updates all the actionable checkpoints in the milestone index based on the user modified actionable checkpoint. Therefore, the number of interactions of the user gets reduced drastically. Thus, the milestone index enables the users to easily modify the choices at a particular point without losing track of the user journey.

Further, when the user tries to modify the actionable checkpoints, if the filter component/input provided by the user is incorrect or out of context then an error message is displayed to the user. Further, the actionable checkpoint is retained as it was before modification and the milestone index is retained accordingly. The user entered filter components/inputs are evaluated for the context and the availability by handlers 112b and services 112c. If both the context and the availability provide a positive result, then the actionable checkpoints are modified and the changes are reflected in the milestone index.

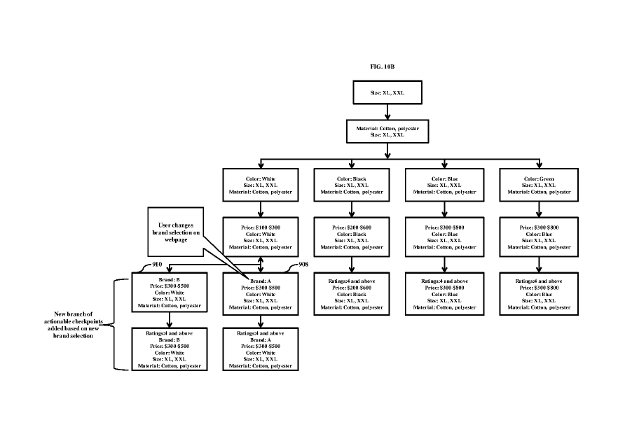

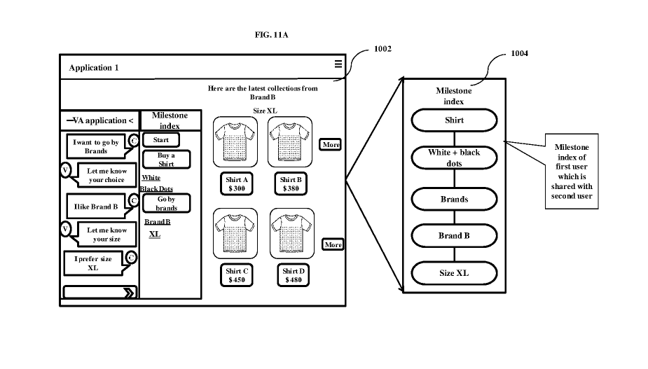

FIGS. 10A-10B illustrates an example scenario of determining changes in user journey and automatically updating the milestone index based on the changes in the user journey, according to an embodiment as disclosed herein.

Consider that the user is browsing through a shopping application to buy a shirt. Consider that the journey of the user through the shopping application is available in the milestone index in the form of actionable checkpoints, as shown in FIG. 10A. At step 902, the user selects the size filter components as XL and XXL which are recorded as actionable checkpoints. At step 904, the user selects the material filter components as cotton and polyester. Similarly, the user applies various other filters for colour preference, price range, ratings of the shirts, etc. The user selections are recorded as actionable checkpoints in the milestone index. Further, every time the user modifies the filter component in the browsing application (i.e., shopping application in this case), the modified filter component applied by the user is added as a new branch in the milestone index.

At step 906, the user modifies the colour filter applied to fetch the results for the shirt to ‘Green’ in the shopping application. The electronic device 100, on determining that the colour filter has been modified, adds a new branch to the milestone index. The new branch of the milestone index indicates the modified colour filter applied to fetch the results for the shirt.

Referring to the FIG. 10B, consider that the user has selected the actionable checkpoint associated with the colour filter ‘White’. The electronic device 100 fetches all the shirts having white colour, with sizes XL or XXL, with material being cotton or polyester, the price range etc. At step 908, the user further refines the search by selecting other filter components such as brand, ratings associated with the shirts, etc. Further, the electronic device 100 displays the result based on the various filter components selected by the user on the screen of the electronic device 100.

At step 910, the user modifies the brand filter component from brand A to brand B on the browsing application. The electronic device 100 determines that the brand filter component has been changed on the browsing application and adds a new branch to the milestone index. The new branch of the milestone index indicates the brand filter component applied to fetch the results for the shirt. Further, as shown in FIG. 10B, the new branch is added at the position where the user changes the brand. The milestone index automatically updates the filters applied after the brand filter component and generates the actionable checkpoints accordingly i.e., the rating filter component applied by the user is the branch containing brand A is automatically updated in the branch containing brand B.

Therefore, the milestone index creates actionable checkpoints for both the actions performed on the browsing window and the VA interactions of the user. Thus the milestone index is constantly updated with any interaction performed by the user in the entire web space.

Therefore, the milestone index helps the users to quickly change the selection/filter component at a specific step with minimum number of interactions on the electronic device 100. Thus, the milestone index enables the users to travel back the search experience seamlessly.

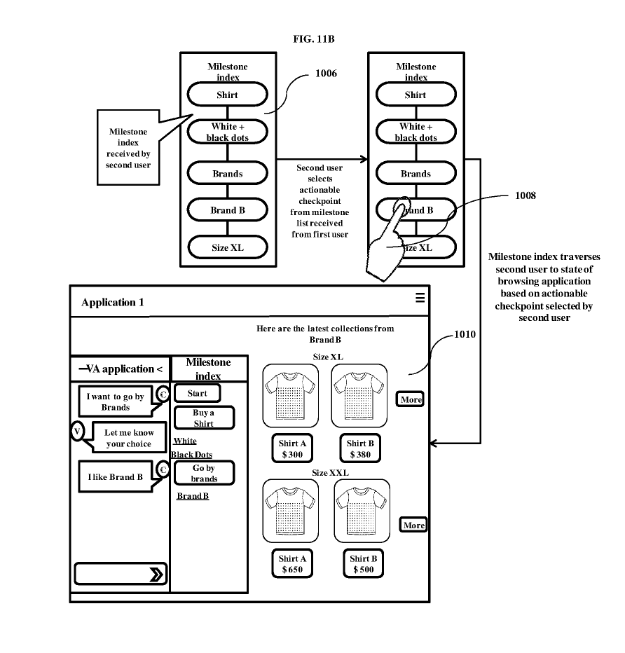

FIGS. 11A-11B illustrates an example scenario of a first user sharing the milestone index with a second user, according to an embodiment as disclosed herein.

Referring to the FIG. 11A, at step 1002, consider that the first user is accessing the shopping application i.e., Application 1. Further, the first user is continuously interacting with the VA application and also performing actions on the shopping application. Therefore, electronic device 100 automatically creates the milestone index for the first user based on the various commands provided by the first user, the response provided by the VA application to the commands provided by the first user and the state of the shopping application (as shown in step 1004). The milestone index has plurality of interconnected actionable checkpoints indicating the browsing journey of the first user on the shopping application. The actionable checkpoints indicate the dynamic actions performed by the first user on the shopping application, the filter components used to perform the dynamic action and the specific state of the shopping application displaying the contents filtered by the first user. The first user shares the milestone index with the second user.

Referring to the FIG. 11B, at step 1006, the second user receives the milestone index shared by the first user. The electronic device 100 of the second user displays the milestone index received from the first user on the portion of the screen of the electronic device 100. Further, the electronic device 100 detects that the second user has selected (at step 1008) one of the actionable checkpoints from the plurality of interconnected actionable checkpoints from the milestone index.

Further, the electronic device 100 extracts the filter component as Brand B which is associated with the actionable check point selected by the second user. The electronic device 100 filters the shirts of Brand B and displays the filtered content on the second portion of the electronic device 100 (as shown in step 1010). Hence, the electronic device 100 of the second user traverses the second user to the specific state of the shopping application in the user journey of the first user.

Therefore, the first user can share the milestone index indicating the user journey of the first user in the browsing application with the second user. The feature of sharing the milestone index is very useful when a group of users are interested to traverse the user journey of a particular user.

For example, consider a company decides to buy a group health insurance policy for the employees. The various filters applied by the manager in determining a suitable group health insurance policy for the employees are recorded in the form of actionable checkpoints on the milestone index of the manager. Further, the manager can share the milestone index to all the employees of the company. Since the milestone index can be modified and updated based on the modification, the individual employees can customize the group health insurance policy based on their individual requirements.

In another embodiment, the milestone index can be stored as a state of the browsing application on the electronic device 100. When the user access the browsing application, the state of the browsing application is restored. Further, restoring the state of the browsing application may be useful on gifting occasions as the state of the browsing application which is recorded as the actionable checkpoint in the milestone index can be shared. For example, user A accesses the browsing application and during the course of user journey, the user A pays for X amount of Dollars. The user journey traversed by the user A before making the payment is saved in the milestone index. Further, the user A can share the milestone index with the user B. The user B can shop or make transaction up to X amount of Dollars as gifted by the user A.

When the user B invokes the gifting action, the respective state of the browsing application is restored and the desired user identification is collected and stored in a server database. When the gifted client (i.e., the user B) invokes the browsing application, the identity of the user B is verified and the respective state of the browsing application which is stored in the server database is retrieved to the electronic device 100 on the user B's side.

The embodiments disclosed herein can be implemented through at least one software program running on at least one hardware device and performing network management functions to control the elements. The elements shown in the FIGS. 1 through 10B include blocks which can be at least one of a hardware device, or a combination of hardware device and software module.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A virtual assistance (VA)-based content interaction method in an electronic device, comprising:
displaying, by a virtual assistant engine, a VA application in a first portion of a screen of the electronic device, and a browsing application in a second portion of the screen of the electronic device;
receiving, by the virtual assistant engine, at least one user command at the VA application in the first portion to view a specific content of the browsing application;
providing, by the virtual assistant engine, at least one response to the at least one user command by the VA application in the first portion while performing a dynamic action to display the specific content of the browsing application in the second portion based on the at least one user command;
automatically creating, by a milestone index engine, a milestone index comprising a plurality of interconnected actionable checkpoints based on the at least one user command, the at least one response to the at least one user command by the VA application, and a state of the browsing application displaying the specific content based on the dynamic action; and
displaying, by the milestone index engine, the milestone index in a third portion of the screen of the electronic device.

2. The method of claim 1, wherein each of the actionable checkpoints indicates the dynamic action, a filter component to perform the dynamic action, and the specific state of the browsing application displaying the specific content filtered based on the filter component.

3. The method of claim 1, wherein performing the dynamic action to display the specific content of the browsing application in the second portion based on the at least one user command comprising:
extracting, by the virtual assistant engine, a filter component from at least one of the at least one user command and the at least one response from the VA application; and
performing, by the virtual assistant engine, the dynamic action by:
determining the specific content by filtering content of the browsing application based on the filter component; and
displaying the specific content of the browsing application in the second portion of the screen.

4. The method of claim 1, further comprising:
detecting, by the milestone index engine, an actionable check point selected from the plurality of interconnected actionable checkpoints displayed in the third portion of the screen;
determining, by the milestone index engine, a dynamic action, a filter component to perform the dynamic action, and a specific state of the browsing application corresponding to the selected actionable check point; and
automatically traversing, by the milestone index engine, to the specific state of the browsing application displaying the specific content filtered based on the filter component in the second portion of the screen.

5. The method of claim 1, further comprising:
detecting, by the milestone index engine, that actionable check point from the plurality of interconnected actionable checkpoints modified by a user; and
automatically updating, by the milestone index engine, the milestone index by modifying at least one of a dynamic action, a filter component to perform the dynamic action, and a specific state of the browsing application corresponding to the selected actionable check point associated with remaining actionable checkpoints from the plurality of interconnected actionable checkpoints based on the modification actionable checkpoint.

6. The method of claim 5, further comprising:
detecting, by the milestone index engine, the modified actionable check point selected from the plurality of modified actionable checkpoints; and
determining, by the milestone index engine, a modified dynamic action, a modified filter component to perform the modified dynamic action, and a modified specific state of the browsing application corresponding to the modified actionable check point; and
automatically traversing, by the milestone index engine, to the modified state of the browsing application displaying the modified specific content filtered based on the modified filter component.

7. The method of claim 1, further comprising sharing the milestone index with other users to dynamically traverse across the specific content of the browsing application.

8. The method of claim 1, wherein the milestone index simulates a browsing journey of a user in the browsing application in the form of actionable checkpoints to allow the user to seamlessly traverse across the specific content of the browsing application.

9. The method of claim 1, wherein the third portion is embedded in or overlaid at the first portion or the second portion of the screen.

10. A virtual assistance (VA)-based content interaction method in an electronic device, comprising:
receiving, by a milestone index engine of a first user, a milestone index comprising a plurality of interconnected actionable checkpoints indicating a browsing journey of a browsing application of a second user;
simulating, by the milestone index engine of the first user, the milestone index of the browsing application of the second user at a first portion of the screen of the electronic device of the first user;
detecting, by the milestone index engine of the first user, an actionable checkpoint selected from the plurality of actionable checkpoints by the first user; and
determining, by the milestone index engine of the first user, a dynamic action to be performed and a filter component used to perform the dynamic action corresponding to the selected actionable check point;
performing, by the milestone index engine of the first user, the dynamic action by filtering content of the browsing application based on the filter component; and
automatically traversing, by the milestone index engine of the first user, the first user to a specific state of the browsing application displaying the filtered content in a second portion of the screen.

11. The method of claim 10, wherein each of the actionable checkpoints indicates the dynamic action, a filter component to perform the dynamic action, and the specific state of the browsing application displaying the specific content filtered based on the filter component.

12. The method of claim 10, wherein the milestone index is dynamically created by:
monitoring, by a milestone index engine, at least user command of the second user at the VA application to view a specific content of the browsing application, at least one response to the at least one user command by the VA application, and at least one specific state of the browsing application displaying a specific content from the browsing application; and
automatically creating, by the milestone index engine, the milestone index comprises the plurality of interconnected actionable checkpoints based on the at least user command, the at least one response to the at least one user command by the VA application, and the at least one state of the browsing application displaying the specific content.

13. The method of claim 10, further comprising:
detecting, by the milestone index engine, that actionable check point from the plurality of interconnected actionable checkpoints modified by a user; and
automatically updating, by the milestone index engine, the milestone index by modifying at least one of a dynamic action, a filter component to perform the dynamic action, and a specific state of the browsing application corresponding to the selected actionable check point associated with remaining actionable checkpoints from the plurality of interconnected actionable checkpoints based on the modification actionable checkpoint.

14. The method of claim 13, further comprising:
detecting, by the milestone index engine, an modified actionable check point selected from the plurality of modified actionable checkpoints; and
determining, by the milestone index engine, a modified dynamic action, a modified filter component to perform the modified dynamic action, and a modified specific state of the browsing application corresponding to the modified actionable check point; and
automatically traversing, by the milestone index engine, to the modified state of the browsing application displaying the modified specific content filtered based on the modified filter component.

15. The method of claim 10, further comprising sharing the milestone index with other users to dynamically traverse across the specific content of the browsing application.

16. A virtual assistance (VA)-based content interaction method in an electronic device, comprising:
simulating, by a milestone index engine, milestone index comprising a plurality of interconnected actionable checkpoints indicating a browsing journey of a user in a browsing application at a first portion of the screen of the electronic device,
detecting, by the milestone index engine, that at least one of a dynamic action and a filter component associated with a first actionable checkpoint from the plurality of interconnected actionable checkpoints are modified by a user; and
automatically updating, by the milestone index engine, the milestone index by modifying at least one of a dynamic action, a filter component used to perform the dynamic action, and a specific state of the browsing application associated with remaining actionable checkpoints from the plurality of interconnected actionable checkpoints based on the modified dynamic action and the modified filter component of the first actionable checkpoint.

17. The method of claim 16, further comprising:
detecting, by the milestone index engine, an modified actionable check point selected from the plurality of modified actionable checkpoints; and
determining, by the milestone index engine, a modified dynamic action, a modified filter component to perform the modified dynamic action, and a modified specific state of the browsing application corresponding to the modified actionable check point; and
automatically traversing, by the milestone index engine, to the modified state of the browsing application displaying the modified specific content filtered based on the modified filter component.

18. The method of claim 16, further comprising sharing the updated milestone index with other users to dynamically traverse across the specific content of the browsing application.

19. The method of claim 16, wherein each of the actionable checkpoints indicates the dynamic action, a filter component to perform the dynamic action, and the specific state of the browsing application displaying the specific content filtered based on the filter component.

20. An electronic device providing a virtual assistance (VA)-based content interaction, comprising:
a memory;
a processor coupled to the memory;
a virtual assistant engine coupled to the processor and the memory, wherein the virtual assistant engine is configured to:
display a VA application in a first portion of a screen of the electronic device, and a browsing application in a second portion of the screen of the electronic device;
receive at least one user command at the VA application in the first portion to view a specific content of the browsing application; and
provide at least one response to the at least one user command by the VA application in the first portion while performing a dynamic action to display the specific content of the browsing application in the second portion based on the at least one user command; and
a milestone index engine coupled to the processor and the memory, wherein the milestone index engine is configured to:
automatically create a milestone index comprising a plurality of interconnected actionable checkpoints based on the at least one user command, the at least one response to the at least one user command by the VA application, and a state of the browsing application displaying the specific content based on the dynamic action; and
display the milestone index in a third portion of the screen of the electronic device, and
a browsing application coupled to the processor and the memory.

21. The electronic device of claim 20, wherein each of the actionable checkpoints indicates the dynamic action, a filter component to perform the dynamic action, and the specific state of the browsing application displaying the specific content filtered based on the filter component.

22. The electronic device of claim 20, wherein the virtual assistant engine is configured to perform the dynamic action to display the specific content of the browsing application in the second portion based on the at least one user command comprises:
extract a filter component from at least one of the at least one user command and the at least one response from the VA application; and
perform the dynamic action by:
determining the specific content by filtering content of the browsing application based on the filter component; and
displaying the specific content of the browsing application in the second portion of the screen.

23. The electronic device of claim 20, the milestone index engine is further configured to:
detect an actionable check point selected from the plurality of interconnected actionable checkpoints displayed in the third portion of the screen;
determine a dynamic action, a filter component to perform the dynamic action, and a specific state of the browsing application corresponding to the selected actionable check point; and
automatically traverse to the specific state of the browsing application displaying the specific content filtered based on the filter component in the second portion of the screen.

24. The electronic device of claim 20, the milestone index engine is further configured to:
detect that actionable check point from the plurality of interconnected actionable checkpoints modified by a user; and
automatically update the milestone index by modifying at least one of a dynamic action, a filter component to perform the dynamic action, and a specific state of the browsing application corresponding to the selected actionable check point associated with remaining actionable checkpoints from the plurality of interconnected actionable checkpoints based on the modification actionable checkpoint.

25. The electronic device of claim 24, the milestone index engine is further configured to:
detect an modified actionable check point selected from the plurality of modified actionable checkpoints; and
determine a modified dynamic action, a modified filter component to perform the modified dynamic action, and a modified specific state of the browsing application corresponding to the modified actionable check point; and
automatically traverse to the modified state of the browsing application displaying the modified specific content filtered based on the modified filter component.

26. The electronic device of claim 20, the milestone index engine is further configured to share the milestone index with other users to dynamically traverse across the specific content of the browsing application.

27. The electronic device of claim 20, wherein the milestone index simulates a browsing journey of a user in the browsing application in the form of actionable checkpoints to allow the user to seamlessly traverse across the specific content of the browsing application.

28. The electronic device of claim 20, wherein the third portion is embedded in or overlaid at the first portion or the second portion of the screen.

29. An electronic device providing a virtual assistance (VA)-based content interaction, comprising:
a memory;
a processor coupled to the memory;
a milestone index engine coupled to the processor and the memory, wherein the milestone index engine is configured to:
receive a milestone index comprising a plurality of interconnected actionable checkpoints indicating a browsing journey of a browsing application of a second user;
simulate the milestone index of the browsing application of the second user at a first portion of the screen of the electronic device of the first user;
detect an actionable checkpoint selected from the plurality of actionable checkpoints by the first user;
determine a dynamic action to be performed and a filter component used to perform the dynamic action corresponding to the selected actionable check point;
perform the dynamic action by filtering content of the browsing application based on the filter component; and
automatically traverse the first user to a specific state of the browsing application displaying the filtered content in a second portion of the screen.

30. The electronic device of claim 30, wherein each of the actionable checkpoints indicates the dynamic action, a filter component to perform the dynamic action, and the specific state of the browsing application displaying the specific content filtered based on the filter component.

31. The electronic device of claim 30, wherein the milestone index is dynamically created by:
monitoring at least user command of the second user at the VA application to view a specific content of the browsing application, at least one response to the at least one user command by the VA application, and at least one specific state of the browsing application displaying a specific content from the browsing application; and
automatically create the milestone index comprising the plurality of interconnected actionable checkpoints based on the at least user command, the at least one response to the at least one user command by the VA application, and the at least one state of the browsing application displaying the specific content.

32. The electronic device of claim 30, the milestone index engine is further configured to:
detect that actionable check point from the plurality of interconnected actionable checkpoints modified by a user; and
automatically update the milestone index by modifying at least one of a dynamic action, a filter component to perform the dynamic action, and a specific state of the browsing application corresponding to the selected actionable check point associated with remaining actionable checkpoints from the plurality of interconnected actionable checkpoints based on the modification actionable checkpoint.

33. The electronic device of claim 33, the milestone index engine is further configured to:
detect a modified actionable check point selected from the plurality of modified actionable checkpoints;
determine a modified dynamic action, a modified filter component to perform the modified dynamic action, and a modified specific state of the browsing application corresponding to the modified actionable check point; and
automatically traverse to the modified state of the browsing application displaying the modified specific content filtered based on the modified filter component.

34. The electronic device of claim 30, the milestone index engine is further configured to share the milestone index with other users to dynamically traverse across the specific content of the browsing application.

35. An electronic device providing a virtual assistance (VA)-based content interaction, comprising:
a memory;
a processor coupled to the memory;
a milestone index engine coupled to the processor and the memory, wherein the milestone index engine is configured to:
simulate milestone index comprising a plurality of interconnected actionable checkpoints indicating a browsing journey of a user in a browsing application at a first portion of the screen of the electronic device,
detect that at least one of a dynamic action and a filter component associated with a first actionable checkpoint from the plurality of interconnected actionable checkpoints are modified by a user; and
automatically update the milestone index by modifying at least one of a dynamic action, a filter component used to perform the dynamic action, and a specific state of the browsing application associated with remaining actionable checkpoints from the plurality of interconnected actionable checkpoints based on the modified dynamic action and the modified filter component of the first actionable checkpoint.

36. The electronic device of claim 35, the milestone index engine is further configured to:
detect a modified actionable check point selected from the plurality of modified actionable checkpoints;
determine a modified dynamic action, a modified filter component to perform the modified dynamic action, and a modified specific state of the browsing application corresponding to the modified actionable check point; and
automatically traverse to the modified state of the browsing application displaying the modified specific content filtered based on the modified filter component.

37. The electronic device of claim 35, the milestone index engine is further configured to share the updated milestone index with other users to dynamically traverse across the specific content of the browsing application.

38. The electronic device of claim 35, wherein each of the actionable checkpoints indicates the dynamic action, a filter component to perform the dynamic action, and the specific state of the browsing application displaying the specific content filtered based on the filter component.
